(19) United States
(12) Patent Application Publication
(10) Pub. No.: US 2017/0062940 A1
(43) Pub. Date: Mar. 2, 2017

(54) COMPACT WIDEBAND DUAL POLARIZED DIPOLE

(71) Applicant: Amphenol Corporation, Wallingford, CT (US)

(72) Inventor: Tan Huy CAO, Hickory, NC (US)

(21) Appl. No.: 15/250,481

(22) Filed: Aug. 29, 2016

Related U.S. Application Data
(60) Provisional application No. 62/211,033, filed on Aug. 28, 2015.

(51) Int. Cl. H01Q 9/44; H01Q 21/24; H01Q 1/38; H01Q 5/50

(52) U.S. Cl. CPC H01Q 9/44; H01Q 5/50; H01Q 21/24; H01Q 1/38

(57) ABSTRACT

A compact wideband dual polarized dipole antenna assembly using a meander line component. The antenna assembly includes a pair of open stub baluns with a radiating dual polarized top printed circuit board (PCB) that is perpendicular to the baluns. The radiating dual polarized top PCB includes the meander line component. The compact dipole solution, through the use of the meander line component, may be employed in more complex multi-band products resulting in a reduction in metal required and does not compromise in performance during multi-band operation. The compact wideband dual polarized dipole antenna assembly covers all known radio frequency bands in, for example, the mobile base station industry to date.

### CROSS REFERENCE TO RELATED APPLICATION(S)

This application claims priority from U.S. Provisional Patent Application. No. 62/211,033, filed on Aug. 28, 2015, which is hereby incorporated herein by reference in its entirety.

### FIELD OF THE INVENTION

Embodiments are in the field of dipole antennas. More particularly, embodiments disclosed herein relate to compact wideband dual polarized dipole antenna assemblies which, inter alia, foster a compact dipole solution through the use of a meander line component that may be employed in more complex multi-band products and that does not compromise in performance during multi-band operation.

### BACKGROUND OF THE INVENTION

The mobile base station industry is becoming increasingly more competitive. As new frequency bands are being made available, it is a goal of those involved in the design and use of mobile base station antennas and other related systems to maintain or reduce costs, while maintaining or improving upon electrical performance across a broader range of frequency bands.

Current antenna structures of, for example, Tri band configurations have to provide some level of performance compromise due to the number of bands which result in asymmetry in horizontal pattern shaping. Embodiments of the present invention provide a dipole that reduces the amount of distortion due to both the reduction in size but also through the reduction in metal (printed circuit board (PCB)-etched) that shadows and acts as a parasitic to the different frequency bands present in the multi-band arrays. The frequency bands of operation have grown over the past decade from narrow band i.e. 800 MHz or 900 MHz to 700-900 MHz and for high bands 1800 MHz, 1900 MHz or 2100 MHz to 1700 MHz-2700 MHz. The larger operating bandwidths have resulted in more compromised performance over the bands of operation that increases both the distortion (azimuth tracking) and cross-polarization discrimination ratio (XPD). The current pattern distortion results in coverage hand-off issues and planning concerns for wireless operators through a parameter of azimuth tracking which can be in excess of 5 dB. Embodiments of the present invention also provide a dipole that reduces the azimuth tracking to <3 dB over the sector of operation)(±60° for a 65° product in multiband configuration and improved XPD of 10 dB at sector edges ±60°.

For comparison purposes with FIG. 5 (discussed below), FIG. 6 is a perspective view of a prior art dipole antenna assembly 1, in an installation configuration, along with a corresponding plot of a radiation pattern during operation of the installed prior art antenna assembly 1.

Current design trends are moving toward increasing the number of bands inside of the existing antenna packages which will make size reduction accomplished via embodiments herein a valuable and indispensable feature.

Accordingly, there exists a need for a compact dual polarized dipole solution with wideband performance that is able to overcome the above disadvantages and that may be employed in more complex multi-band products satisfying strictly product size requirements and does not compromise in performance during multi-band operation.

Advantages of the present invention will become more fully apparent from the detailed description of the invention herein below.

### SUMMARY OF THE INVENTION

Embodiments are directed to a dual-polarized dipole antenna assembly. The dipole antenna assembly comprises: a first balun having a first polarization; a second balun having a second polarization different from the first polarization; and a radiating dual polarized printed circuit board (PCB) that is positioned above and perpendicular to the first and second baluns. The PCB comprises meander line components associated with the first and second polarizations.

In an embodiment, each of the meander line components may comprise a conductor oriented in a rectangular wave pattern provided on a dielectric substrate of the PCB. Each conductor may be positioned on a single surface of the dielectric substrate.

In an embodiment, the PCB comprises first and third quadrants associated with the first polarization, and second and fourth quadrants associated with the second polarization, wherein the first and third quadrants are on opposite portions of the PCB, and the second and fourth quadrants are on opposite portions of the PCB, and wherein the first, second, third, and fourth quadrants are respectively radially positioned around the PCB. Each of the first, second, third, and fourth quadrants may be substantially sector-shaped. Each of the first, second, third, and fourth quadrants may further comprise a radially extended portion. The radially extended portions of the first and third quadrants may comprise the meander line components associated with the first polarization, and the radially extended portions of the second and fourth quadrants may comprise the meander line components associated with the second polarization. Each of the meander line components associated with the first polarization and the second polarization may comprise a conductor oriented in a rectangular wave pattern provided on a dielectric substrate of the PCB. Each conductor may be positioned on a single surface of the dielectric substrate. The conductor of the meander line component of the radially extended portion of each of the first and third quadrants may be electromagnetically coupled with a conductor of the first balun, and wherein the conductor of the meander line component of the radially extended portion of each of the second and fourth quadrants may be electromagnetically coupled with a conductor of the second balun.

In an embodiment, the first balun and the second balun are arranged in a ±45° configuration, and the first polarization is perpendicular to the second polarization thereby producing two orthogonal polarization states.

In an embodiment, the first balun is perpendicular to the second balun, and the first polarization is perpendicular to the second polarization thereby producing two orthogonal polarization states.

In an embodiment, the first balun and the second balun intersect one another to form a general x-shape, and the first polarization is perpendicular to the second polarization thereby producing two orthogonal polarization states.

In an embodiment, the dipole antenna assembly is scalable and capable of operating at various frequency bands—including but not limit to 698-960 MHz, 1700-2700 MHz and 3300-3900 MHz.

### BRIEF DESCRIPTION OF THE DRAWINGS

The detailed description will refer to the following drawings, wherein like reference numerals refer to like elements, and wherein:

FIG. 1A is a perspective view of a schematic diagram illustrating a dual-polarized dipole antenna assembly, in accordance with an exemplary embodiment of the invention;

FIG. 1B is a side view of the antenna assembly shown in FIG. 1A;

FIG. 2 is another perspective view of the antenna assembly shown in FIG. 1A, along with a superimposed outline-schematic illustrating a prior art dipole antenna assembly, for comparison purposes;

FIG. 2A is a top view of the antenna assembly of FIG. 2;

FIG. 2B shows a balun of FIG. 2;

FIG. 2C shows another balun of FIG. 2;

FIG. 3 is another perspective view of the antenna assembly shown in FIG. 1A, in an exemplary installation configuration. The antenna assembly is shown connected to an upper surface within a package;

FIG. 4 is a plot of Return-Loss and Isolation during operation of the installed antenna assembly shown in FIG. 3;

FIG. 5 is another perspective view of an antenna assembly shown in FIG. 1A, in another exemplary installation configuration, along with a corresponding plot of a radiation pattern during operation of the installed antenna assembly;

FIG. 6 is a perspective view of a prior art dipole antenna assembly, in an installation configuration, along with a corresponding plot of a radiation pattern during operation of the installed prior art antenna assembly;

FIG. 7 is a perspective view of four of the antenna assemblies shown in FIG. 1A, in another exemplary installation configuration, along with a corresponding plot of an azimuth (Azi) pattern during operation of all the installed antenna assemblies;

FIG. 8A is a perspective view of three of the antenna assemblies shown in FIG. 1A, in another exemplary installation configuration;

FIG. 8B is a plot of an azimuth (Azi) pattern during operation of all the installed antenna assemblies shown in FIG. 8A;

FIG. 8C is a plot of an Elevation (Ele) pattern during operation of all the installed antenna assemblies shown in FIG. 8A;

FIG. 9 is a perspective view of two of the antenna assemblies shown in FIG. 1A, in another exemplary installation configuration; as shown in FIG. 9, the radiating dual polarized top PCBs are illustrated, for simplicity purposes, as only including meander line components; and

FIG. 10 is a perspective view of forty-eight (48) down-scaled versions of the antenna assembly shown in FIG. 1A, in a 12×4 large scale array (LSA) exemplary installation configuration with half-wavelength element spacing.

### DETAILED DESCRIPTION OF THE PREFERRED EMBODIMENTS

It is to be understood that the figures and descriptions of the present invention may have been simplified to illustrate elements that are relevant for a clear understanding of the present invention, while eliminating, for purposes of clarity, other elements found in a typical dipole antenna assembly. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

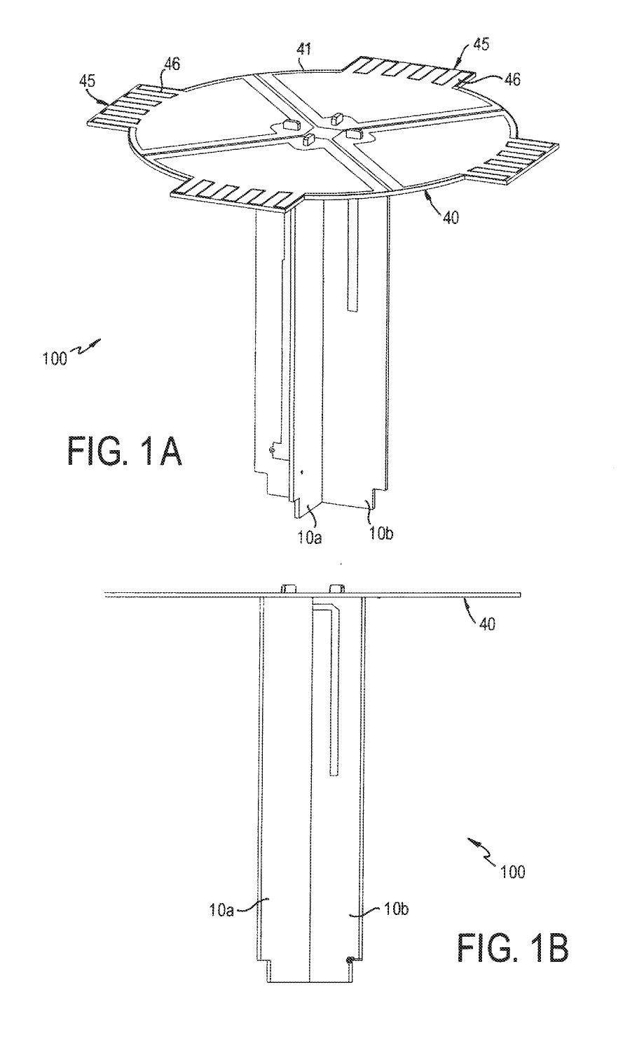

With reference to FIG. 1A, shown is a perspective view of a schematic diagram illustrating a dual-polarized dipole antenna assembly 100, in accordance with an exemplary embodiment of the invention. An embodiment of the present invention is shown in FIG. 1A as including a PCB-etched set of components that comprise a pair of open stub baluns 10a, 10b (i.e., one for each polarization) and a radiating dual polarized top PCB 40 which resides in a plane that is above and perpendicular to longitudinal axes of the baluns 10a, 10b. In other words, embodiments are directed to a dual-polarized dipole antenna assembly 100 comprising: a first balun 10a having a first polarization; a second balun 10b having a second polarization different from the first polarization; and a radiating dual polarized printed circuit board (PCB) 40 that is positioned above and perpendicular to the first balun 10a and the second balun 10b.

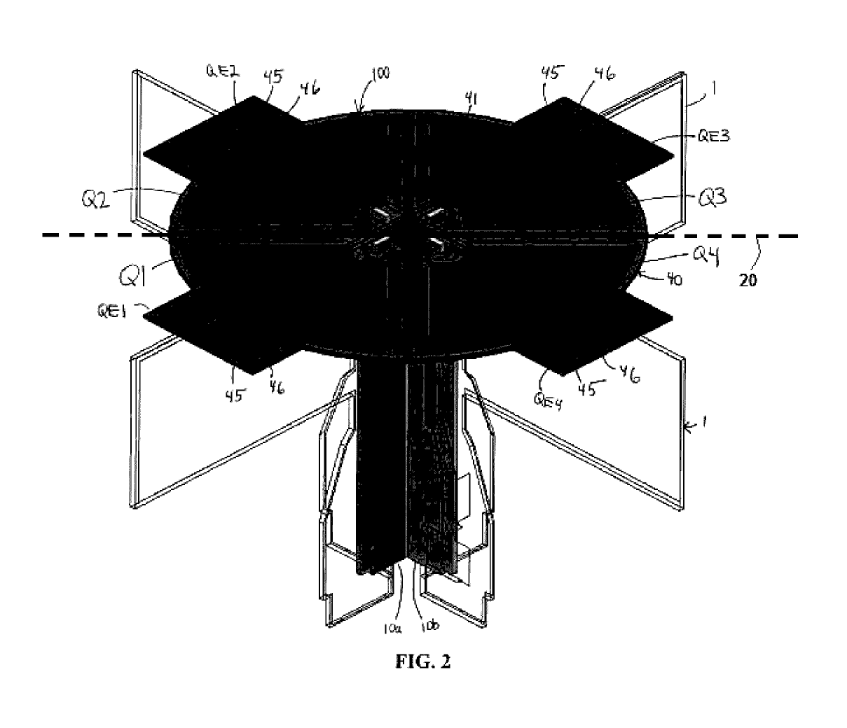

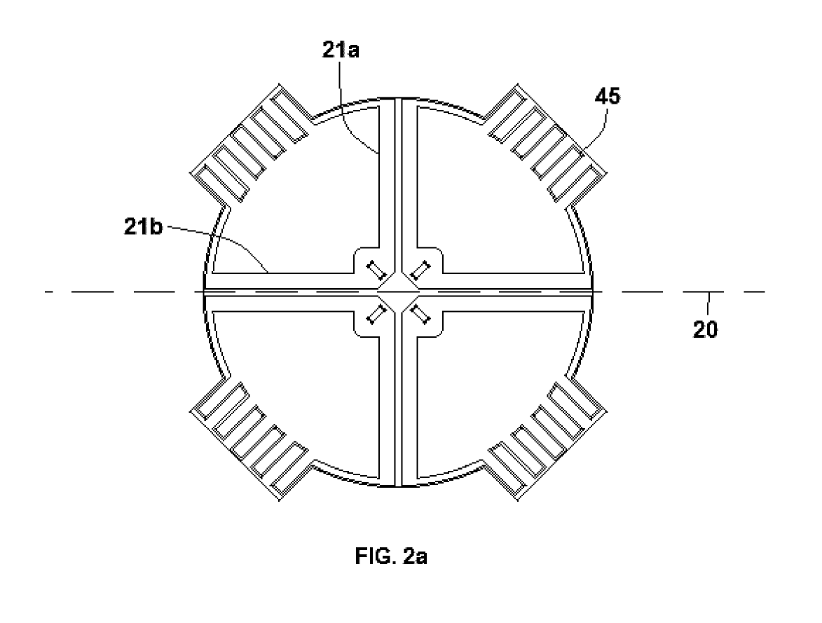

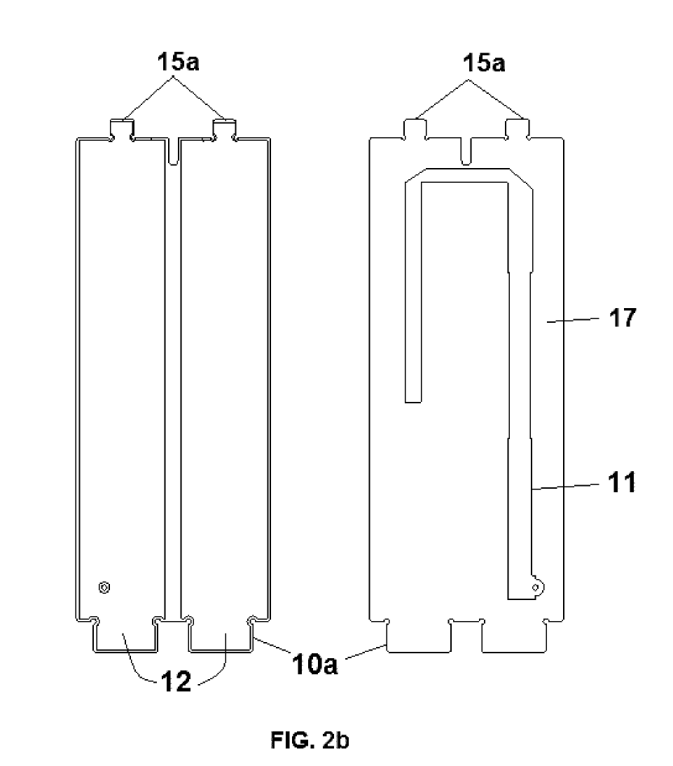

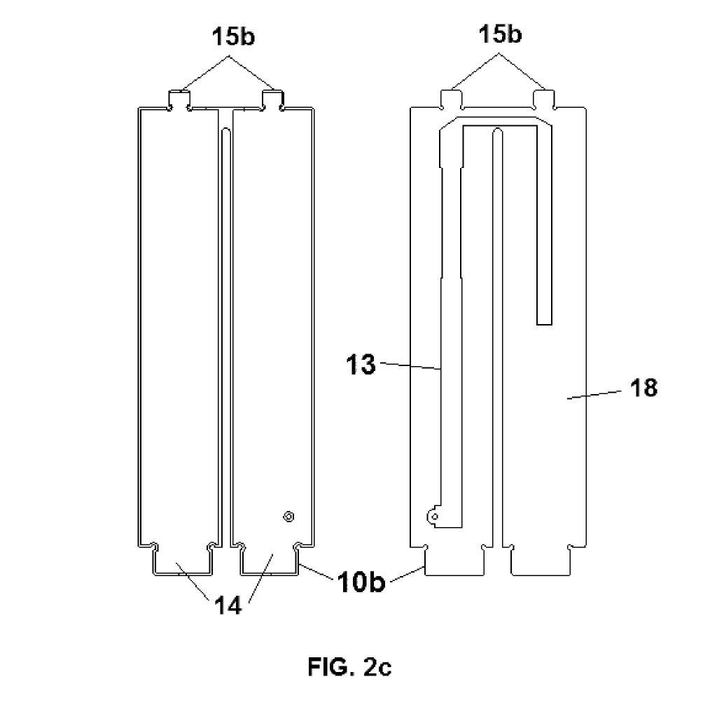

The PCB 40 is acting as a radiator and provides equivalent RF performance as that of conventional half-wave cross-dipoles. The particular PCB design and orientation. For instance in FIG. 2A, the total length of two perpendicular thin lines 21a, 21b and the unique meander loops 45 in each quadrant, as well as the gap created between each adjacent quadrant are configured and optimized to enable a desired radiation pattern with key parameters to be achieved, such as half-power beam-width, x-pol discrimination, front-to-back and front-to-side ratio, beam squinting and tracking. Other important baseline RF characteristics such as return-loss and isolation are also achieved.

The PCB 40 comprises two identical pair of dipoles (Q1, Q3 & Q2, Q4) that are non-intersecting and perpendicular to each other forming a circular-shaped radiator. As shown in FIG. 2A, a first pair of dipoles Q1, Q3 is oriented at a −45 degree angle to the axis 20 of the antenna. A second pair of dipoles Q2,Q4 is oriented at a 45 degree angle to the axis 20 of the antenna. The quadrants are separated by the dielectric substrate 41. Referring to FIGS. 2B, 2C, each balun PCB 10a, 10b has a metal ground plane layer 12, 14 and a hook-shaped balun feed probe 11, 13. The balun PCBs 10a, 10b also have a pair of tabs 15a, 15b on top of which pass through four (4) small slots in the base of the PCB 40. The ground plane layers 12, 14 are soldered to the each meaner line quadrant of the PCB 40. The balun PCBs 10a, 10b are fitted together in a crossed configuration and oriented 45 degrees to the axis 20 of the antenna. The substrate sides 17, 18 have a dielectric constant (DK) that is chosen to provide impedance matching from a feed network below to the balun feed probes 11, 13.

The dipoles pairs Q1/Q3 and Q2/Q4 are flat and formed opposite to each other on the PCB 40. Each quadrant from each pair of dipoles is arrow-shaped (i.e., including radially extended portions QE1-QE4) and includes a thin line of conductive material (i.e., PCB-etched) that is bent as a respective meander line 45 which extends in a region outside and at a vertex of each quadrant. The meander line 45 consists of several loops that are closely grouped and configured so that the overall size of each quadrant is reduced but still able to satisfy electrical length needed to function as a quarter-wavelength arm conductor of a half-wave dipole. As a result, the overall size of the radiator is reduced as well. The number of meander loops are configured to operate at a wide band frequency of 698-960 MHz, although it can also be arranged to be used for other frequency ranges as well.

The PCB 40 is ideally arranged approximately one-quarter wavelength above a ground plane 19 and perpendicular to the baluns so that it can be couple-fed by the baluns and provide a RF path from a microstrip feeding network sharing the same RF ground as the radiating antenna. Also, the horizontally-mounted PCB 40 are structurally supported by a crossed pair of balun PCBs (10a, 10b) that are vertically mounted. FIG. 1B is a side view of the antenna assembly 100 shown in FIG. 1A. As shown in FIG. 1B, the antenna assembly 100 forms a general T-shape with the baluns 10a, 10b extending downwardly from PCB 40.

The PCB 40 comprises meander line components 45 (see, for example, FIGS. 1A and 2) associated with the first and second polarizations. Each of the meander line components 45 may comprise a conductor 46 oriented in a rectangular wave pattern provided on a dielectric substrate 41 of the PCB 40. Each conductor 46 may be positioned on a single surface of the dielectric substrate 41.

The meander line component 45 comprises embedding (or placing) a conductor 46 (e.g., wire structure) within (or onto) a dielectric substrate. The conductor 46 is folded back and forth to make the overall length of the conductor shorter than the original length of a corresponding straight conductor. The meander line component 45 comprises a set of horizontal and vertical lines (i.e., right-angled lines) which forms turns. As the number of turns increases, the efficiency increases. As the conductor spacing increases between the turns, the resonant frequency decreases. The meander line component 45 may be a combination of (or one of either of) conventional wire and planar strip lines which include the benefits of configuration simplicity, easy integration to wireless devices, and potential for low specific absorption rate features.

In an embodiment, the PCB 40 includes first and third quadrants (Q1, Q3, respectively—see FIG. 2) associated with the first polarization, and second and fourth quadrants (Q2, Q4, respectively—see also FIG. 2) associated with the second polarization. The first and third quadrants Q1, Q3 are on opposite portions of the PCB 40, and the second and fourth quadrants Q2, Q4 are on opposite portions of the PCB 40. The first, second, third, and fourth quadrants Q1-Q4 are respectively radially positioned around the PCB 40. Each of the first, second, third, and fourth quadrants Q1-Q4 may be substantially sector-shaped. Each of the first, second, third, and fourth quadrants Q1-Q4 may further include a radially extended portion QE1, QE2, QE3, QE4, respectively. Each radially extended portion QE1, QE2, QE3, QE4 extends outwardly from an outer periphery of Q1, Q2, Q3, Q4, respectively. Each radially extended portion QE1, QE2, QE3, QE4 may be of substantially rectangular shape. The respective radially extended portions QE1, QE3 of the first and third quadrants Q1, Q3 each may include a meander line component 45 associated with the first polarization. The respective radially extended portions QE2, QE4 of the second and fourth quadrants Q2, Q4 each may include a meander line component 45 associated with the second polarization. Each of the meander line components 45 associated with the first polarization and the second polarization may include a conductor 46 oriented in a rectangular wave pattern provided on a dielectric substrate 41 of the PCB 40. Each conductor 46 may be positioned on a single surface of the dielectric substrate 41. The conductor 46 of the meander line component 45 of the respective radially extended portion QE1, QE3 of each of the first and third quadrants Q1, Q3 may be electromagnetically coupled with a conductor of the first balun 10a. The conductor 46 of the meander line component 45 of the respective radially extended portion QE2, QE4 of each of the second and fourth quadrants Q2, Q4 may be electromagnetically coupled with a conductor of the second balun 10b.

Embodiments herein relate to a compact wideband dual polarization dipole antenna assembly (i.e., radiating element). A key aspect of embodiments of the present invention is the size of the dipole has been significantly reduced through the use of a meander line component. The reduction may result in a 27-30% smaller design as compared to conventional half-wave cross-dipole designs, while maintaining the horizontal and vertical orthogonal components to meet the performance requirements necessary to produce two orthogonal polarization states. This smaller design as compared to larger dipole antenna assemblies/structures has the benefits of not only reduced cost but also allows for more compact and complex multi-band products, as well as massive multiple input and multiple output (MIMO) antenna array or LSA for 5G technology.

In an embodiment, the first balun 10a and the second balun 10b are arranged in a ±45° configuration, and the first polarization is perpendicular to the second polarization thereby producing two orthogonal polarization states.

In an embodiment, the first balun 10a is perpendicular to the second balun 10b, and the first polarization is perpendicular to the second polarization thereby producing two orthogonal polarization states.

In an embodiment, the first balun 10a and the second balun 10b intersect one another to form a general x-shape, and the first polarization is perpendicular to the second polarization thereby producing two orthogonal polarization states.

In an embodiment, the dipole antenna assembly 100 is capable of operating at wideband frequency of 698-960 MHz.

FIG. 2 is another perspective view of the antenna assembly 100 shown in FIG. 1A, along with a superimposed outline-schematic illustrating a prior art dipole antenna assembly 1, for comparison purposes. Dipole antenna assembly 100 operates similar to prior art dipole antenna assembly 1, albeit in a smaller overall package. Each dipole antenna assembly 1, 100 is able to produce two orthogonal radiation patterns simultaneously with similar RF characteristics in performance.

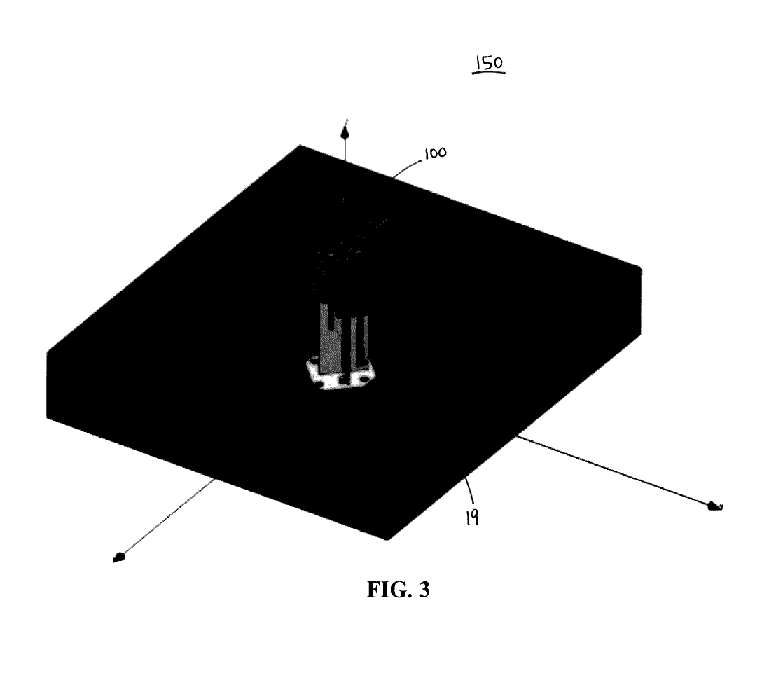

FIG. 3 is another perspective view of the antenna assembly 100 shown in FIG. 1A, in an exemplary installation configuration. Antenna assembly 100 is shown connected to an upper surface of a ground plane 19 within a package 150.

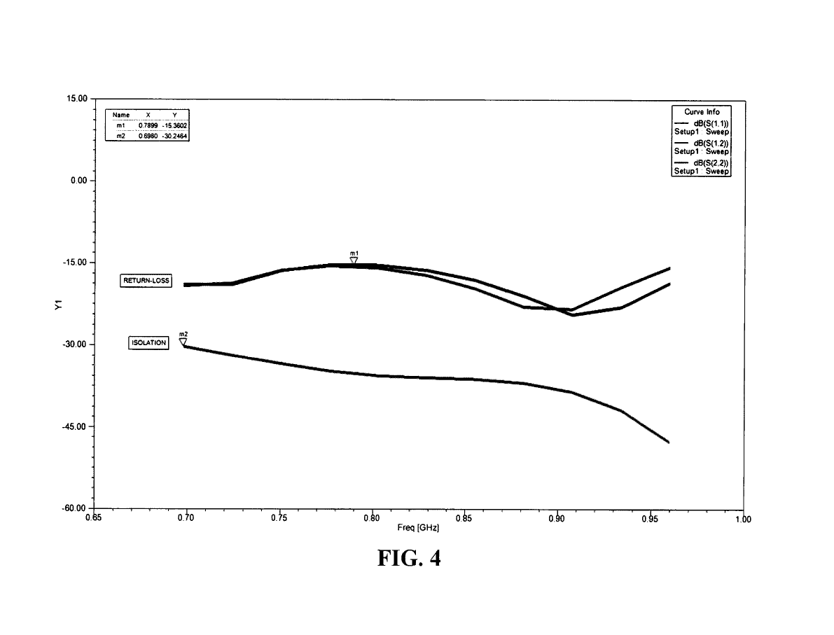

FIG. 4 is a plot of return-loss (RL) and isolation (ISO) during operation of the installed antenna assembly shown in FIG. 3.

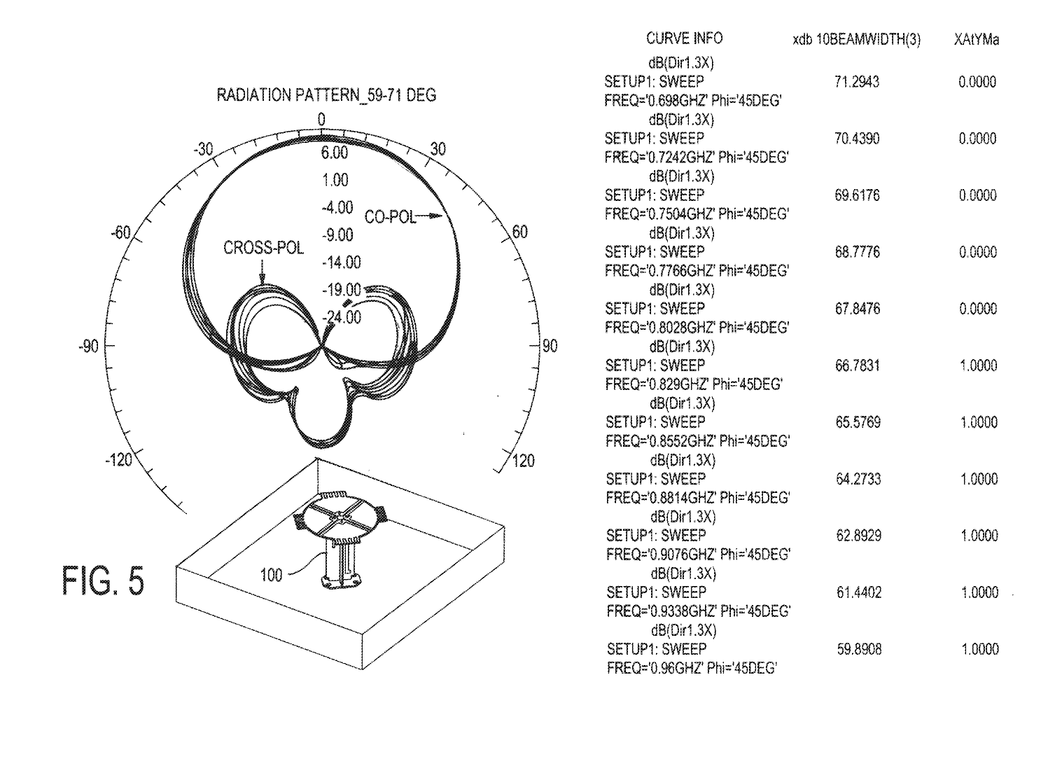

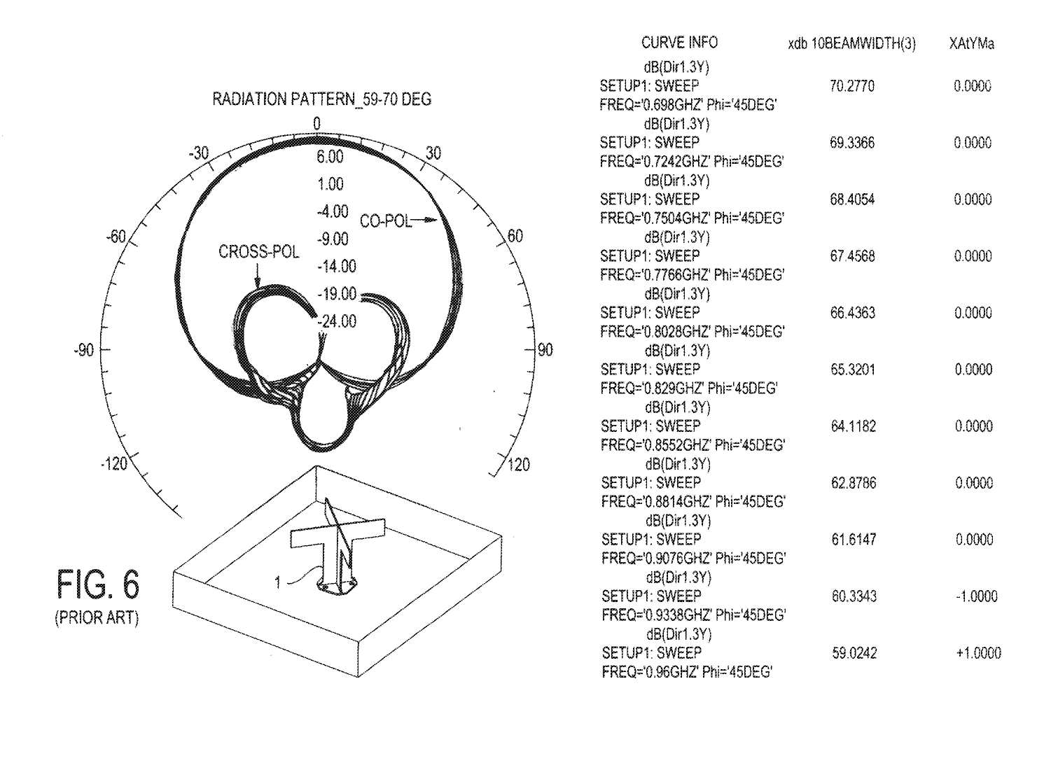

FIG. 5 is another perspective view of the antenna assembly 100 shown in FIG. 1A, in another exemplary installation configuration, along with a corresponding plot of a radiation pattern during operation of the installed antenna assembly 100. As seen, the radiation pattern plot in FIG. 5 is similar to the plot in FIG. 6. The comparison shows an insignificant difference in RF performance between the configuration shown in FIG. 5 and the prior art configuration shown in FIG. 6. Both radiation patterns with key parameters and RF characteristics are similar. Thus even with a smaller physical size, key RF parameters are also achieved, such as half-power beam-width, x-pol discrimination, front-to-back and front-to-side ratio, beam squinting and tracking, and other desirable RF characteristics such as return-loss and isolation.

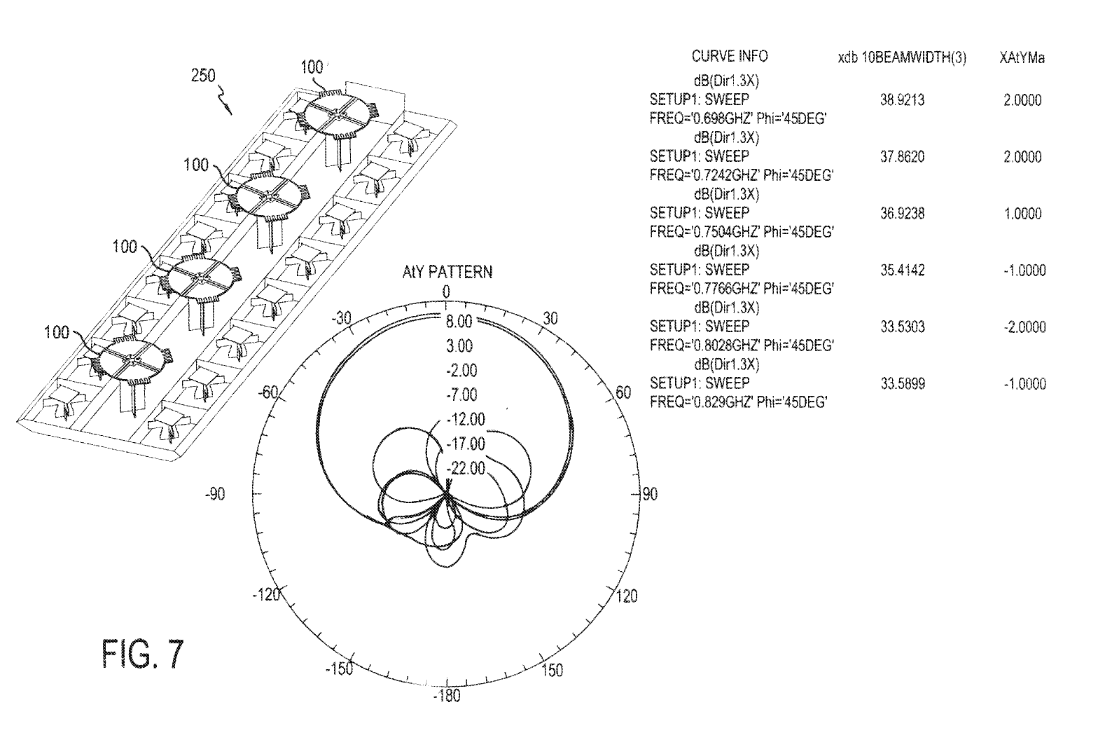

FIG. 7 is a perspective view of four of the antenna assemblies 100 shown in FIG. 1A, in another exemplary installation configuration, along with a corresponding plot of an azimuth (Azi) pattern during operation of all the installed antenna assemblies 100. Antenna assemblies 100 are installed within package 250. In this particular multi-band antenna product, the high-band antenna is placed in between two low-band antennas. With the low-band dipole being smaller in physical size, it helps minimize the adverse effect of blocking (shadowing) and also reduces unwanted mutual coupling between the low-band and high-band elements. Thus, there is a first row of low-band antennas, a second row of high-band antennas, and a third row of low-band antennas. The second row is disposed between the first and second rows so that each high-band antenna has a low-band antenna on either side in one direction (across rows), and one or more neighboring high-band antennas in a perpendicular direction (within the same row). As a result, both high-band antennas may be placed in close proximity to the low-band antenna with no substantial degradation to their radiation patterns. Thereby, the overall size of the multi-band antenna product is greatly reduced.

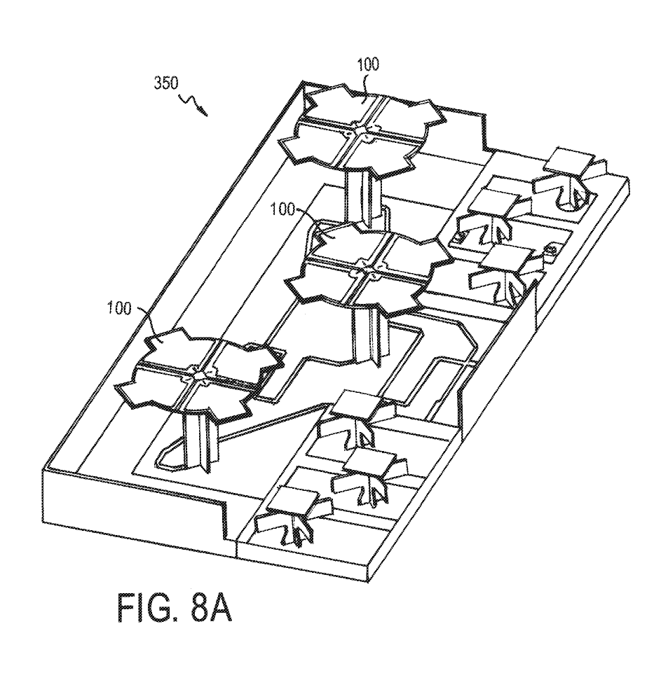

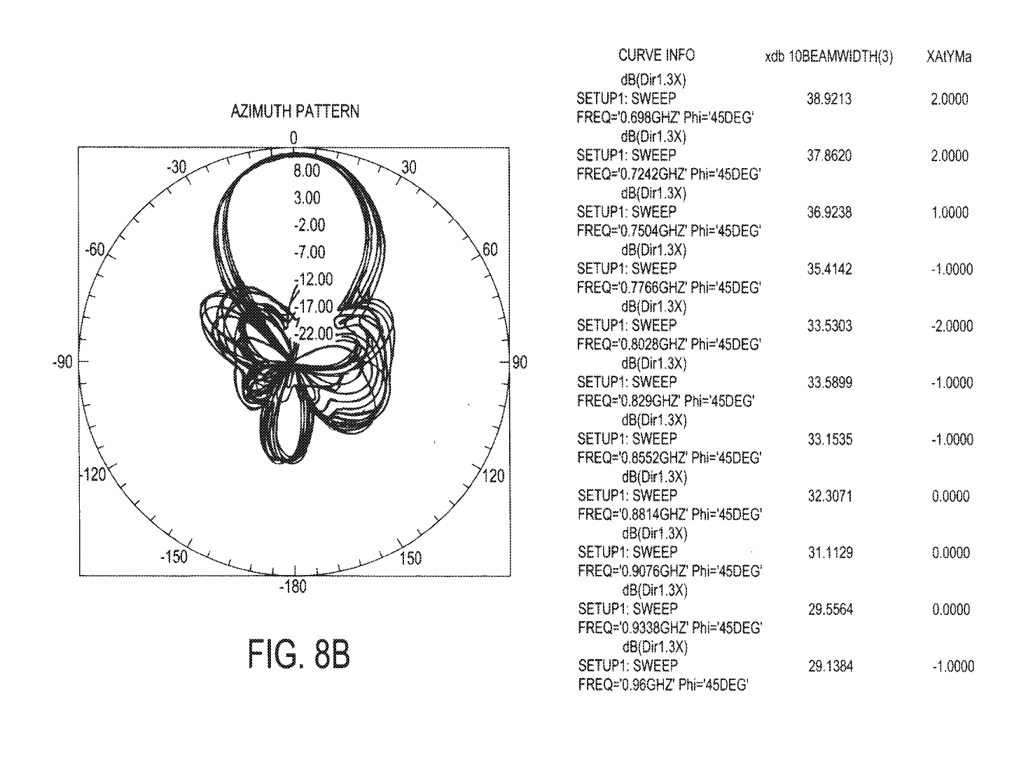

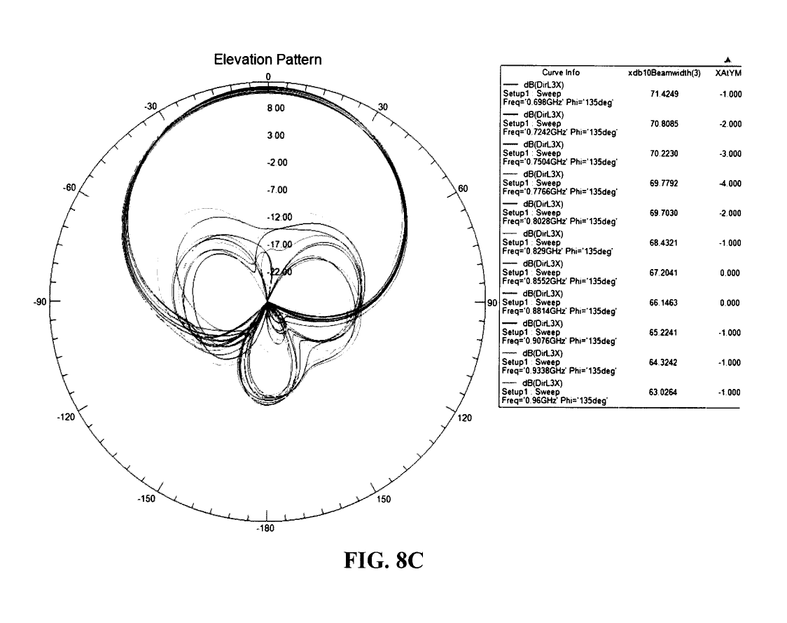

FIG. 8A is a perspective view of three of the antenna assemblies 100 shown in FIG. 1A, in another exemplary installation configuration. Antenna assemblies 100 are installed within package 350. In this particular multi-band antenna product, the low-band antenna is staggeredly placed adjacent to two staggered high-band antennas. Thus the three low-band antennas are grouped together at two different sections of the board (two corners along a same side of the board, in the embodiment shown), and can either be aligned or offset with respect to each other. And the three high-band antennas are grouped together at another section of the board, and can either be aligned or offset with respect to each other. With the low-band dipole being smaller in size, it helps minimize the adverse effect of blocking (shadowing) and also reduces unwanted mutual coupling between the low-band and high-band elements. As a result, both high-band antennas may be placed in close proximity to the low-band antenna with no substantial degradation to their radiation patterns. Thereby, the overall size of the multi-band antenna product is reduced.

FIG. 8B is a plot of an azimuth (Azi) pattern during operation of all the installed antenna assemblies 100 shown in FIG. 8A.

FIG. 8C is a plot of an Elevation (Ele) pattern during operation of all the installed antenna assemblies 100 shown in FIG. 8A.

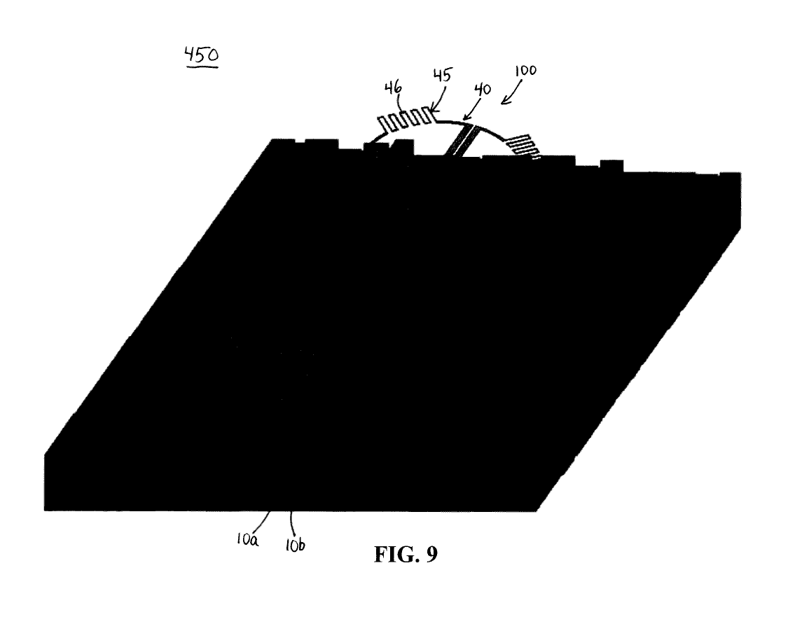

FIG. 9 is a perspective view of two of the antenna assemblies 100 shown in FIG. 1A, in another exemplary installation configuration. As shown in FIG. 9, the radiating dual polarized top PCBs 40 are illustrated, for simplicity purposes, as only including meander line components 45. Antenna assemblies 100 are installed within package 450. The benefits of this configuration is similar to that described above with reference to FIG. 7.

As lower frequency bands are opened up for wireless communications, e.g., 600 MHz, the natural increase in lambda would require an increase in the aperture to maintain similar performance and cell coverage. The present design per, for example, the embodiments herein will allow for a reduction in the required increase in size which translates to a reduction in operating expense for operators when leasing “area”-controlled sites as well as ease of zoning and capital expenditures. For narrow beam products that require multi-column architecture, this compact design will allow for higher number of band additions without increased package size.

The compact dipole solution, through the use of the meander line component, may be employed in more complex multi-band products satisfying strictly product size requirements and does not compromise in performance during multi-band operation. The compact wideband dual polarized dipole antenna assembly covers all known radio frequency bands in, for example, the mobile base station industry to date. In addition, the antenna assembly is also capable of covering a relative higher frequency band (e.g., 3.5 GHz band) in embodiments using a massive MIMO array or LSA array for potential 5G applications in the future.

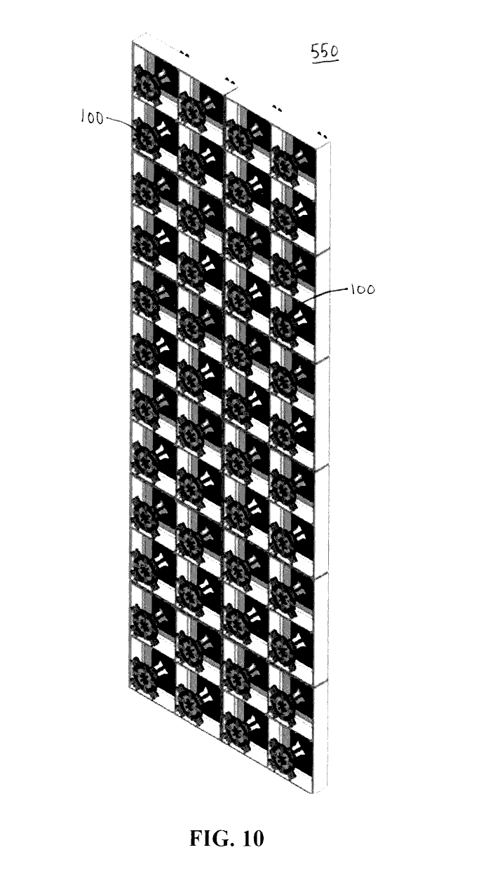

FIG. 10 is an embodiment illustrating a perspective view of forty-eight (48) down-scaled versions of the antenna assembly 100 shown in FIG. 1A, in a 12×4 LSA exemplary installation configuration with half-wavelength element spacing. Antenna assemblies 100 are installed within the package 550 in rows and columns to form an array. Each element is identical unit cell, forming a planar 12 rows by 4 columns array, separated by metallic walls in both vertical and horizontal direction, with the spacing equal of half-wavelength. This arrangement achieves a maximum tilting angle by placing the antenna elements in such a close spacing. The antennas operate at 3.5 GHz and the embodiment is a single band application. This embodiment is suitable, for example, for operating in the 3.5 GHz band, which is a potential 5G application. The massive MIMO or LSA requires relatively smaller spacing between the adjacent elements than the traditional passive antenna array, e.g. half-wavelength spacing in the massive MIMO or LSA array vs. ¾ wavelength spacing in a traditional 10-degree down tilt passive antenna array, for the achievement of a larger tilting angle for the beamforming realization. This is an advanced performance in 5G technology over the current passive antenna array. The traditional radiating elements including, but not limited to, the half-wavelength dipole and patch antenna element may either not mechanically fit in such a small spacing structure or have server mutual coupling among adjacent elements that degrade the port to port isolation of single element and the XPD of the array radiation pattern.

In addition, the patch radiating element in such a restricted spacing array usually suffers from the narrow bandwidth. With the down-scaled version of the antenna assemblies 100, the configuration can achieve better than −20 dB port to port isolation despite the location of the element in the LSA structure. This occurs while having a larger than 90 degree Azi beamwidth, a smaller than −10 dB XPD @ 10 dB, an elevation tilting angle as wide as 45 degrees and 16.67% bandwidth. This proves itself to be a good candidate for the LSA or massive MIMO array for 5G beamforming technology. Although this embodiment has 12×4 down-scaled versions of the antenna assembly 100, any size of M×N (M, N∈integer) array may alternatively be realized with the antenna assembly 100 or down/up scaled versions of it for different frequency band applications.

Although embodiments are described above with reference to a dipole antenna assembly including a PCB-etched set of components that comprise a pair of open stub baluns and a radiating dual polarized top PCB that is above and perpendicular to the baluns, embodiments may alternatively be directed to a dipole antenna assembly that includes a cable feed using a pair of cables per polarization as well as a molded or cast dipole assembly/structure. Such alternatives are considered to be within the spirit and scope of the present invention, and may therefore utilize the advantages of the configurations and embodiments described above.

Although the embodiments described above may operate in a transmit mode and receive mode, embodiments may also be implemented and configured to operate in a transmit mode only or receive mode only. Such alternatives are considered to be within the spirit and scope of the present invention, and may therefore utilize the advantages of the configurations and embodiments described above.

In addition, although embodiments are described above with reference to a dipole antenna assembly employing ±45° polarization states, the dipole antenna assembly described in any of the above embodiments may alternatively be used in horizontal/vertical (H/V) or circular polarizations. Such alternatives are considered to be within the spirit and scope of the present invention, and may therefore utilize the advantages of the configurations and embodiments described above.

Features in any of the embodiments described in this disclosure may be employed in combination with features in other embodiments described herein, such combinations are considered to be within the spirit and scope of the present invention.

The contemplated modifications and variations specifically mentioned in this disclosure are considered to be within the spirit and scope of the present invention.

More generally, even though the present disclosure and exemplary embodiments are described above with reference to the examples according to the accompanying drawings, it is to be understood that they are not restricted thereto. Rather, it is apparent to those skilled in the art that the disclosed embodiments can be modified in many ways without departing from the scope of the disclosure herein. For instance, more or fewer high-band and/or low-band antennas can be provided in any embodiment. Moreover, the terms and descriptions used herein are set forth by way of illustration only and are not meant as limitations. Those skilled in the art will recognize that many variations are possible within the spirit and scope of the disclosure as defined in the following claims, and their equivalents, in which all terms are to be understood in their broadest possible sense unless otherwise indicated.

1. A dual-polarized dipole antenna assembly comprising:
a first balun having a first polarization;
a second balun having a second polarization different from the first polarization; and
a radiating dual polarized printed circuit board (PCB) that is positioned above and perpendicular to the first and second baluns, wherein the PCB comprises meander line components associated with the first and second polarizations.

2. The dipole antenna assembly of claim 1, wherein each of the meander line components comprises a conductor oriented in a rectangular wave pattern provided on a dielectric substrate of the PCB.

3. The dipole antenna assembly of claim 2, wherein each conductor is positioned on a single surface of the dielectric substrate.

4. The dipole antenna assembly of claim 1, wherein the PCB comprises first and third quadrants associated with the first polarization, and second and fourth quadrants associated with the second polarization, wherein the first and third quadrants are on opposite portions of the PCB, and the second and fourth quadrants are on opposite portions of the PCB, and wherein the first, second, third, and fourth quadrants are respectively radially positioned around the PCB.

5. The dipole antenna assembly of claim 4, wherein each of the first, second, third, and fourth quadrants are substantially sector-shaped.

6. The dipole antenna assembly of claim 5, wherein each of the first, second, third, and fourth quadrants further comprises a radially extended portion.

7. The dipole antenna assembly of claim 6, wherein the radially extended portions of the first and third quadrants comprise the meander line components associated with the first polarization, and wherein the radially extended portions of the second and fourth quadrants comprise the meander line components associated with the second polarization.

8. The dipole antenna assembly of claim 7, wherein each of the meander line components associated with the first polarization and the second polarization comprises a conductor oriented in a rectangular wave pattern provided on a dielectric substrate of the PCB.

9. The dipole antenna assembly of claim 8, wherein each conductor is positioned on a single surface of the dielectric substrate.

10. The dipole antenna assembly of claim 9, wherein the conductor of the meander line component of the radially extended portion of each of the first and third quadrants are electromagnetically coupled with a conductor of the first balun, and wherein the conductor of the meander line component of the radially extended portion of each of the second and fourth quadrants are electromagnetically coupled with a conductor of the second balun.

11. The dipole antenna assembly of claim 1, wherein the first balun and the second balun are arranged in a ±45° configuration, and the first polarization is perpendicular to the second polarization thereby producing two orthogonal polarization states.

12. The dipole antenna assembly of claim 1, wherein the first balun is perpendicular to the second balun, and the first polarization is perpendicular to the second polarization thereby producing two orthogonal polarization states.

13. The dipole antenna assembly of claim 1, wherein the first balun and the second balun intersect one another to form a general x-shape, and the first polarization is perpendicular to the second polarization thereby producing two orthogonal polarization states.

14. The dipole antenna assembly of claim 1, wherein the dipole antenna assembly is scalable and capable of operating at various frequency bands—including but not limit to 698-960 MHz, 1700-2700 MHz and 3300-3900 MHz.
